(19) United States
(12) Patent Application Publication
(10) Pub. No.: US 2015/0005216 A1
(43) Pub. Date: Jan. 1, 2015

(54) Corrosion resistance when using chelating agents in carbon steel-containing equipment

(71) Applicant: Akzo Nobel Chemicals International B.V., Amersfoort (NL)

(72) Inventors: Cornelia Adriana De Wolf, Eerbeek (NL); Albertus Jacobus Maria Bouwman, Groessen (NL); Hisham Nasr-El-Din, College Station, TX (US)

(73) Assignee: Akzo Nobel Chemicals International B.V., Amersfoort (NL)

(21) Appl. No.: 14/376,878

(22) PCT Filed: Feb. 11, 2013
(86) PCT No.: PCT/EP2013/052687

§ 371 Date: Aug. 6, 2014

Related U.S. Application Data
(60) Provisional application No. 61/597,950, filed on Feb. 13, 2012.

(30) Foreign Application Priority Data
Feb. 28, 2012 (EP) 12157218.4

(51) Int. Cl. C09K 8/54; C23F 11/04; C23G 1/08

(52) U.S. Cl. CPC C09K 8/54; C23G 1/088; C23F 11/04
USPC 510/188; 134/3; 134/201; 134/166 R

(57) ABSTRACT

The present invention relates to the use of solutions containing glutamic acid N,N-diacetic acid or a salt thereof (GLDA) and/or methylglycine N,N-diacetic acid or a salt thereof (MGDA) in treating subterranean formations, wherein the solutions contact carbon steel-containing equipment, and to a system containing a carbon steel-containing material in contact with a solution containing glutamic acid N,N-diacetic acid or a salt thereof (GLDA) and/or methylglycine N,N-diacetic acid or a salt thereof (MGDA), at elevated temperatures and/or employing carbon steel types as usually found in subterranean formations.

The present invention relates to a method to reduce the corrosion of carbon steel-containing equipment. The invention also relates to the use of solutions containing glutamic acid N,N-diacetic acid or a salt thereof (GLDA) and/or methylglycine N,N-diacetic acid or a salt thereof (MGDA) that are contacted with carbon steel-containing equipment, in the treatment of subterranean formations, but also to the use thereof as a chemical in carbon steel-containing equipment, for example as a chemical in a plant or factory that contains carbon steel-containing tanks, boilers, tubes or other equipment, for example to clean or descale such equipment or downstream equipment in the oil/gas field/industry. Finally, the invention relates to carbon steel-containing equipment containing a solution containing glutamic acid N,N-diacetic acid or a salt thereof (GLDA) and/or methylglycine N,N-diacetic acid or a salt thereof (MGDA) or to a combined system that contains a carbon steel-containing material in contact with a solution containing glutamic acid N,N-diacetic acid or a salt thereof (GLDA) and/or methylglycine N,N-diacetic acid or a salt thereof (MGDA).

More in particular, the present invention relates to any of the above methods, uses, equipment or systems wherein compared to the state of the art the use of a corrosion inhibitor can be greatly reduced or in some cases even omitted, especially in view of the high temperature and high pressure conditions that are often experienced in the oil and/or gas field.

Carbon steel is defined as a steel, i.e. an alloy with as main component iron, containing carbon as another component in an amount of 0.05-2 wt %, wherein no minimum content is specified or required for chromium, cobalt, molybdenum, nickel, niobium, titanium, tungsten, vanadium or zirconium, or any other element to be added to obtain a desired alloying effect, wherein the specified minimum for copper does not exceed 0.40 wt %, and wherein the maximum content specified for any of the following elements does not exceed the percentages noted: manganese 1.65, silicon 0.60, copper 0.60 wt %. It should be noted that all percentages given on the carbon steel ingredients in this document are weight percentages based on the total alloy.

Carbon steels are by far the most frequently used steels and in many industrial environments like plants, factories, but in particular in oil and gas production installations, a large part of the equipment, such as tubes, tanks, boilers, reactor vessels, is made from carbon steel alloys. Also a lot of carbon steel is applied in oil platforms. However, under the influence of oxygen, hydrogen sulfide (H₂S), carbon dioxide, and a number of other corrosive chemicals, like chloride-containing chemicals, and a large group of acids, carbon steel alloys also suffer negative degradation and corrosion effects, especially at an elevated temperature.

Hence, there has been a continued search for processes to clean and descale equipment and for chemicals that do not have the above problems when contacted with carbon steel material to replace previously used chemicals in the oil and/or gas field and industry.

LePage et al. in “An Environmentally Friendly Stimulation Fluid for High-Temperature Applications,” SPE Journal March 2011, pp. 104-110 disclose that a GLDA based fluid very effectively dissolves CaCO₃ and is less corrosive to the equipment and easy to handle. The corrosion potential of GLDA solutions was tested on completely immersed coupons of cut low-carbon steel (SAE 1020) at 158° F. (70° C.) and atmospheric pressures for one week under static conditions. The corrosion rate was calculated on the basis of weight loss of the coupons. At lower temperatures and higher pH values, significantly less corrosion of the low-carbon steel was found. LePage et al. further disclose that there is a need to use a suitable corrosion inhibitor if GLDA is used at high temperatures or used at low temperatures for a longer period of time. LePage et al. do not disclose or consider corrosion behaviour under subterranean conditions. In addition, LePage et al. disclose only the corrosion behaviour over a low-carbon steel (SAE 1020) that is typically used for simple structural application such as cold headed bolts, axles, general engineering parts and components, machinery parts, shafts, camshafts, gudgon pins, ratchets, light duty gears, worm gears, and spindles. The carbon steels that are typically used in treating subterranean formations, or in the oil and gas field in general, are selected for their durability under typical oil field uses and conditions, such as high temperatures, high pressures, the presence of corrosive gases, and for the transport of hydrocarbons and other liquids and solids.

W. Frenier et al. in “Hot Oil and Gas Wells Can Be Stimulated Without Acids,” SPE Production & Facilities, November 2004, pp 189-199 disclose that the use of N-hydroxyethyl ethylenediamine N,N′,N′-triacetic acid (HEDTA) has much lower undesired corrosion side effects on N-80 carbon steel effects than do a number of other chemicals playing a role in the oil field wherein the use of steel is common practice.

The purpose of the present invention is to provide new chemicals and solutions for use in the treatment of subterranean formations that give an even more minimized corrosion side effect over a broad pH range, and to provide processes to clean or descale carbon steel-containing equipment or to run a number of chemical processes wherein the corrosion is minimized, especially under subterranean conditions which include varying temperature and pH conditions and, in particular, elevated temperature and pressure conditions.

It has now been found that solutions of glutamic acid N,N-diacetic acid or a salt thereof (GLDA) and of methylglycine N,N-diacetic acid or a salt thereof (MGDA) when used in subterranean formations give a surprisingly and significantly lower corrosion of carbon steel than other chelating agent-containing and/or acidic solutions, over a broad pH and temperature range.

Accordingly, the present invention provides alternative processes, systems, and uses of the above solutions that can replace state of the art uses, processes, and systems that suffer from negative corrosion effects.

The present invention provides uses of solutions containing glutamic acid N,N-diacetic acid or a salt thereof (GLDA) and/or methylglycine N,N-diacetic acid or a salt thereof (MGDA) in treating subterranean formations wherein during said use the solution is contacted with carbon steel-containing equipment typically found in subterranean formations wherein in the carbon steel at least one of the metals manganese or chromium is present in an amount of 0.75 wt % or more on the total steel alloy weight, such as, but not limited to, N-80, L-80, P-110, Q-125, J-55, C-75, C-90, C-95, QT-800, QT-900, 5LX-42, and 5LX-52 carbon steel, and/or wherein during said use the solution is contacted with carbon steel-containing equipment and the temperature during the treatment is at least 100° C.

The above uses in treating a subterranean formation are aimed at exploring oil and/or gas from the subterranean formation and/or at descaling or cleaning the carbon steel-containing equipment used therein.

The present invention additionally provides a method to reduce the corrosion of carbon steel-containing equipment. The method contains a step of contacting the carbon steel-containing equipment with a solution containing glutamic acid N,N-diacetic acid or a salt thereof (GLDA) and/or methylglycine N,N-diacetic acid or a salt thereof (MGDA), wherein the solution has a temperature of at least 100° C. and/or wherein in the carbon steel at least one of the metals manganese or chromium is present in an amount of 0.75 wt % or more on the total steel alloy weight, such as, but not limited to, N-80, L-80, P-110, Q-125, J-55, C-75, C-90, C-95, QT-800, QT-900, 5LX-42, and 5LX-52 carbon steel.

The invention not only relates to the use of solutions containing glutamic acid N,N-diacetic acid or a salt thereof (GLDA) and/or methylglycine N,N-diacetic acid or a salt thereof (MGDA) in carbon steel-containing equipment for treating subterranean formations and/or for cleaning or descaling equipment used in the oil/gas field industry, but also may act in the oil/gas field industry as a chemical in such carbon steel-containing equipment, for example as a chemical in a plant or factory that contains carbon steel-containing tanks, boilers, tubes or other equipment, replacing other chemicals, and includes the use in pickling, completions, descaling, and stimulation by acidizing, and fracturing. Chemicals that can be replaced by GLDA or MGDA are chelating agents but also acids, because it is possible to make concentrated acidic solutions of MGDA and even more concentrated more acidic solutions of GLDA. In preferred embodiments the solutions of the invention are used as acidic chemicals, i.e. they are acidic solutions that have a pH of below 7, preferably of below 5, and even more preferably of below 4. In yet another embodiment they have a pH of more than 1, preferably more than 2. Once again, these methods and uses inherently take place at the conditions one often finds in subterranean formations, such as an elevated temperature and/or pressure, and contacting the carbon steels that are found in equipment applied for such treatments and uses.

The present invention also provides the use of improved chelating agent-containing and acidic or alkaline solutions, such as the use of such solutions in cleaning or descaling of equipment in the oil/gas field (often such cleaning or descaling solutions will contain water, a chelating agent, a surfactant, a base or acid, and, optionally, further ingredients), and the use of such solutions in the oil/gas field for treating a subterranean formation (e.g. often containing a solvent such as water, a chelating agent, a surfactant, and a corrosion inhibitor, and often being acidic solutions), wherein the amount of corrosion inhibitor can be greatly decreased or even omitted.

The invention also provides carbon steel-containing equipment containing a solution that contains glutamic acid N,N-diacetic acid or a salt thereof (GLDA) and/or methylglycine N,N-diacetic acid or a salt thereof (MGDA) or a combined system that contains a carbon steel-containing material in contact with a solution containing glutamic acid N,N-diacetic acid or a salt thereof (GLDA) and/or methylglycine N,N-diacetic acid or a salt thereof (MGDA), wherein the solution has a temperature of at least 100° C. and/or wherein in the carbon steel at least one of the metals manganese or chromium is present in an amount of 0.75 wt % or more on the total steel alloy weight, such as, but not limited to, N-80, L-80, P-110, Q-125, J-55, C-75, C-90, C-95, QT-800, QT-900, 5LX-42, and 5LX-52 carbon steel.

The carbon steel-containing equipment may for example be a tube, tank, vessel, or pipe or of any other form that can hold a solution or through which a solution can flow. The carbon steel-containing material may be a carbon steel-containing piece of equipment but also a sheet or plate or a carbon steel-containing piece in any other form (like for example a screw or nail).

The term treatment of a subterranean formation in this application is intended to cover any treatment of the formation with the fluid. It specifically covers treating the formation with the fluid to achieve at least one of (i) an increased permeability, (ii) the removal of small particles, and (iii) the removal of inorganic scale, and so enhance the well performance and enable an increased production of oil and/or gas from the formation. At the same time it may cover cleaning of the wellbore and descaling of the oil/gas production well and production equipment, like pipelines, pumps, tanks, casing, containers, tubular, and other equipment used in oil and gas fields or oil refineries.

The term pickling in this application covers a process or use in which scale, rust, and similar deposits are removed from the internal surfaces of equipment such as treating lines, pumping equipment or the tubing string through which an acid or chemical treatment is to be pumped. The pickling process or use is aimed at removing materials that may react with the main treatment fluid to create undesirable secondary reactions or precipitates damaging to the near-wellbore reservoir formation.

The solution for uses according to the invention containing GLDA and/or MGDA in one embodiment may contain other components, such as primarily water, but also other solvents like alcohols, glycols, and further organic solvents or mutual solvents, soaps, surfactants, dispersants, emulsifiers, pH control additives, such as further acids or bases, biocides/bactericides, water softeners, bleaching agents, enzymes, brighteners, fragrances, antifouling agents, antifoaming agents, anti-sludge agents, corrosion inhibitors, corrosion inhibitor intensifiers, viscosifiers, wetting agents, diverting agents, oxygen scavengers, carrier fluids, fluid loss additives, friction reducers, stabilizers, rheology modifiers, gelling agents, scale inhibitors, breakers, salts, brines, particulates, crosslinkers, salt substitutes, relative permeability modifiers, sulfide scavengers, fibres, nanoparticles. In a preferred embodiment the solutions contain water as a solvent, which may be e.g. fresh water, produced water, boiler water, or sea water. In another preferred embodiment and depending on the conditions that influence the corrosion rate, like temperature, pH, and the presence of corrosive gases, the solution contains more than 0 up to 3 vol % or more preferably more than 0 to 1, and even more preferably more than 0 to 0.5 vol % of a corrosion inhibitor, preferably a corrosion inhibitor of the group of phosphate esters, amine salts of (poly)carboxylic acids, quaternary ammonium and iminium salts and zwitterionics, amidoamines and imidazolines, amides, polyhydroxy and ethoxylated amine/amides, other nitrogen heterocyclics, sulfur compounds and polyaminoacids and other polymeric water-soluble corrosion inhibitors, even more preferably an alkoxylated fatty amine, polymeric ester quat or alkyl poly glucoside.

For the purposes of this application, a mutual solvent is defined as a chemical additive that is substantially soluble in oil, water, acids (often HCl based), and other well treatment fluids, wherein substantially soluble means soluble in more than 10 grams per liter, preferably more than 100 grams per liter. The mutual solvent is preferably present in an amount of 1 to 50 wt % on total solution. In one embodiment of the process of the present invention, the mutual solvent is not added to the same fluid as the treatment fluid containing GLDA or MGDA but introduced into the subterranean formation in or as a preflush or postflush fluid. Mutual solvents are routinely used in a range of applications, controlling the wettability of contact surfaces before, during and/or after a treatment, and preventing or breaking emulsions. Mutual solvents are used, as insoluble formation fines pick up organic film from crude oil. These particles are partially oil-wet and partially water-wet. This causes them to collect material at any oil-water interface, which can stabilize various oil-water emulsions. Mutual solvents remove organic films leaving them water-wet, thus emulsions and particle plugging are eliminated. If a mutual solvent is employed, it is preferably selected from the group which includes, but is not limited to, lower alcohols such as methanol, ethanol, 1-propanol, 2-propanol, and the like, glycols such as ethylene glycol, propylene glycol, diethylene glycol, dipropylene glycol, polyethylene glycol, polypropylene glycol, polyethylene glycol-polyethylene glycol block copolymers, and the like, and glycol ethers such as 2-methoxyethanol, diethylene glycol monomethyl ether, and the like, substantially water/oil-soluble esters, such as one or more C2-esters through C10-esters, and substantially water/oil-soluble ketones, such as one or more C2-C10 ketones,

In the solutions as used in this invention the amount of GLDA and/or MGDA is suitably between 1 and 50 wt % for GLDA and between 1 and 40 wt % for MGDA. Preferably, the amount is between 5 and 30 wt %, even more preferably between 10 and 25 wt %, all based on the total weight of the solutions.

The solutions may be used at several elevated temperature ranges, suitably more than 20° C., preferably more than 80° C., even more preferably of more than 100° C., and in a preferred embodiment of up to 200° C. The solutions are preferably used at pressures of between 2 bar and 2000 bar, more preferably between 10 and 1000 bar. These temperatures and pressures correspond to temperatures and pressures as they are found in subterranean formations and thus in the oil and/or gas industry.

The carbon steels of the present invention in further embodiments can be selected from the groups of low-carbon steels, medium-carbon steels, high-carbon steels, and ultrahigh-carbon steels. Each of them has a different carbon content, wherein the carbon content has an effect on mechanical properties, with increasing carbon content leading to increased hardness and strength. More preferably, the physical properties and chemical composition of the carbon steel are suitable for application in subterranean formations, including elevated temperatures and pressures, flow of gases, fluids and solids and the presence of corrosive gases. Preferred carbon steels are carbon steels wherein at least one of the metals manganese or chromium is present in an amount of 0.75 wt % or more on the total steel alloy weight, such as, but not limited to, N-80, L-80, P-110, Q-125, J-55, C-75, C-90, C-95, QT-800, QT-900, 5LX-42, and 5LX-52 carbon steels.

In one embodiment the carbon steel of the invention is low-carbon steel, with low-carbon steels containing up to 0.30 wt % of carbon on total weight of the steel alloy. The carbon content for high-formability steels is very low, less than 0.10 wt % of carbon, with up to 0.4 wt % manganese on total weight of the steel alloy. For rolled steel structural plates and sections, the carbon content may be increased to approximately 0.30 wt %, with higher manganese content up to 1.5 wt %. These materials may be used for stampings, forgings, seamless tubes, and boiler plate.

In another embodiment the carbon steel of the invention is medium-carbon steel, with medium-carbon steels being similar to low-carbon steels except that the carbon content ranges from 0.30 to 0.60 wt % and the manganese content ranges from 0.60 to 1.65 wt % on total weight of the steel alloy. Increasing the carbon content to approximately 0.5% with an accompanying increase in manganese allows medium-carbon steels to be used in the quenched and tempered condition.

In yet another embodiment the carbon steel of the invention is a high-carbon steel, with high-carbon steels containing from 0.60 to 1.00 wt % of carbon with manganese contents ranging from 0.30 to 0.90 wt % on total weight of the steel alloy.

In another embodiment the carbon steel of the invention is an ultrahigh-carbon steel, with ultrahigh-carbon steels being experimental alloys containing 1.25 to 2.0 wt % carbon on total weight of the alloy. These steels are processed thermomechanically to produce microstructures that consist of ultrafine, equiaxed grains of spherical, discontinuous proeutectoid carbide particles.

Another embodiment of the invention covers carbon steels called high-strength low-alloy (HSLA) steels, or microalloyed steels, which are designed to provide better mechanical properties and/or greater resistance to atmospheric corrosion than carbon steels in the normal sense, because they are designed to meet specific mechanical properties rather than a chemical composition. HSLA steels have low carbon contents (0.05-0.25% C) in order to produce adequate formability and weldability, and they have manganese contents up to 2.0 wt %. Small quantities of chromium, nickel, molybdenum, copper, nitrogen, vanadium, niobium, titanium, and zirconium are used in various combinations.

The group of HSLA steels covers several subgroups, which are all within the scope of the present invention, such as weathering steels, designed to exhibit superior atmospheric corrosion resistance, control-rolled steels, hot-rolled according to a predetermined rolling schedule, designed to develop a highly deformed austenite structure that will transform to a very fine equiaxed ferrite structure on cooling, pearlite-reduced steels, strengthened by very fine-grain ferrite and precipitation hardening but with low carbon content and therefore little or no pearlite in the microstructure, microalloyed steels, with very small additions of such elements as niobium, vanadium and/or titanium for refinement of grain size and/or precipitation hardening, acicular ferrite steels, very low-carbon steels with sufficient hardenability to transform on cooling to a very fine high-strength acicular ferrite structure rather than the usual polygonal ferrite structure, and dual-phase steels, processed to a microstructure of ferrite containing small uniformly distributed regions of high-carbon martensite, resulting in a product with low yield strength and a high rate of work hardening, thus providing a high-strength steel of superior formability.

The various types of HSLA steels may also have small additions of calcium, rare earth elements, or zirconium for sulfide inclusion shape control.

Preferably, the present invention relates to carbon steels containing more than 0 and up to 0.60 wt % of carbon, even more preferably up to 0.30 wt % of carbon (i.e. low-carbon steels).

### EXAMPLES

Corrosion tests were performed in a 1 liter Büchi autoclave (max. pressure 1,500 psi) which contains a glass liner to prevent any other metal/acid contact than for the test coupon itself. The thermocouple was also equipped with a glass liner. The weights and sizes of the test coupons were accurately measured before the test Before the test, the coupon was cleaned with isopropyl alcohol. The total volume of acid was 0.4 liter. The corrosion is determined as the weight loss of the metal coupon after 6 hours at testing conditions. A carbon steel coupon was submerged in the test liquid with a PTFE cord. After assembly and closure of the autoclave, the vapour space was purged 3 times with a small amount of nitrogen. The autoclave was brought up to a pressure of 400-800 psi (about 28-55 bar) with N₂ and subsequently the autoclave contents were heated to the desired temperature with an oil bath. The pressure rose further up to 500 psi (approx 35 bar) to between 1,000, and 1,200 psi (approx 70 and 83 bar). As soon as the measurement temperature was reached, a timer was started. The respective pressure of the equipment was maintained during the whole test. After 6 hours the autoclave was cooled with water to <70° C. in 20 minutes. The pressure was relieved and the unit was purged again with nitrogen. The unit was opened and the steel coupon retrieved. After the test, the metal coupon was cleaned with a bristle brush and water. The corrosion was determined as the weight loss of the test coupon after 6 hours at the simulated downhole conditions.

The specific compositions of the carbon steels that were used in the Examples are given in Tables 1, 2 and 3.

Table 4 gives the dimensions of the steel coupons as used.

TABLE 1
The composition of the L-80 steel coupons used for the corrosion tests
described in Examples 1 and 2

| Element | Content (wt %) |
|---|---|
| C | 0.24 |
| Mn | 1.25 |
| Si | 0.2 |
| Cu | 0.1 |
| Ni | 0.05 |
| Cr | 0.35 |
| Mo | 0.1 |
| Fe | Balance |

TABLE 2
The composition of the L-80 steel coupons used for the corrosion tests in Examples 3 and 4

| Material | C (%) | Mn (%) | P (%) | S (%) | Si (%) | Cu (%) | Ni (%) | Cr (%) | Mo (%) | Al (%) | Fe (%) |
|---|---|---|---|---|---|---|---|---|---|---|---|
| L-80 | 0.27 | 1.18 | 0.08 | 0.05 | 0.24 | 0.02 | 0.01 | 0.19 | 0.10 | 0.03 | B |

B* = balance

TABLE 3
The composition of the various carbon steel coupons used for the corrosion tests in Example 5.

| Material | C (%) | Mn (%) | P (%) | S (%) | Si (%) | Cu (%) | Ni (%) | Cr (%) | Mo (%) | Al (%) | Fe (%) |
|---|---|---|---|---|---|---|---|---|---|---|---|
| L-80 | 0.22 | 1.25 | 0.05 | 0.05 | 0.22 | 0.06 | 0.05 | 0.35 | 0.12 | 0.04 | B |
| C-95 | 0.26 | 1.28 | 0.14 | 0.09 | 0.24 | 0.02 | 0.04 | 0.06 | 0.10 | 0.02 | B |
| Q-125 | 0.28 | 0.49 | 0.01 | 0.00 | 0.25 | 0.01 | 0.01 | 1.04 | 0.32 | 0.02 | B |
| J-55 | 0.35 | 1.34 | 0.01 | 0.01 | 0.25 | — | — | — | — | 0.02 | B |
| P-110 | 0.28 | 1.34 | 0.01 | 0.01 | 0.24 | 0.01 | 0.01 | 0.20 | 0.18 | 0.02 | B |

B* = balance

TABLE 4
The dimensions of the steel coupons used for the corrosion tests

| Dimension | mm | Inch |
|---|---|---|
| Length | 19.050 | ¾″ |
| Wide | 12.700 | ½″ |
| Thick | 1.587 | 1/16″ |
| Hole diameter | 5.08 | ⅕″ |

### Example 1

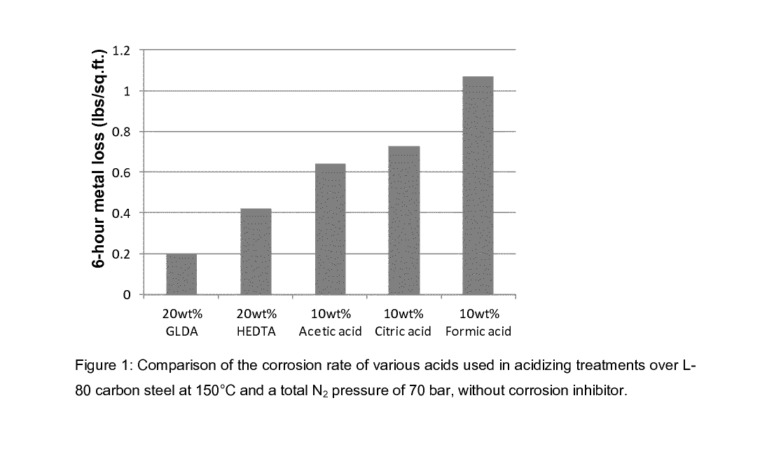

The corrosion behaviour of a 20 wt % GLDA solution (pH=3.8), 20 wt % HEDTA solution (pH=3.8), 10 wt % acetic acid, 10 wt % citric acid, and 10 wt % formic acid was compared over L-80 steel at 150° C. and 70 bar. The results are given in FIG. 1 and show that GLDA without corrosion inhibitor is significantly more gentle to carbon steel than other acids typically used for oil and gas well acid stimulation treatments. The generally accepted corrosion rate in the oil and gas industry for this type of metal and under these conditions is 0.05 lbs/ft² (approx. 0.0244 g/cm²). To meet this requirement a corrosion inhibitor was found to be needed for all acids tested under these conditions.

### Example 2

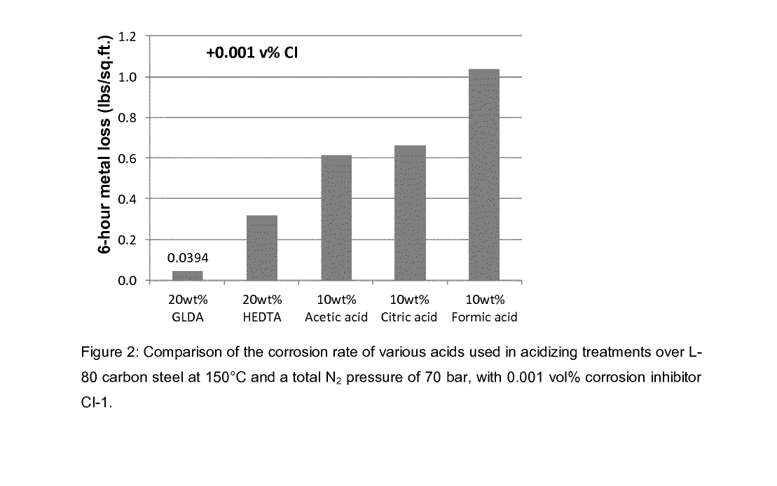

The corrosion behaviour of a combination of 20 wt % GLDA solution (pH=3.8), 20 wt % HEDTA solution (pH=3.8), 10 wt % acetic acid, 10 wt % citric acid or 10 wt % formic acid with a commercially available corrosion inhibitor (CI-1; Armohib 31, obtained from AkzoNobel Surface Chemistry) was compared over L-80 carbon steel at 150° C. and 70 bar. FIG. 2 shows that the addition of 0.001 vol % corrosion inhibitor reduces the corrosion rate of GLDA to 0.0394 lbs/ft² (approx 0.0192 g/cm²), which is below the acceptable corrosion rate of 0.05 lbs/ft² (approx. 0.0244 g/cm²). With the same concentration of corrosion inhibitor the corrosion rate caused by other acids tested is still above the limit.

It can thus be concluded that it is possible to use GLDA in this field, i.e. using a common carbon steel for the oil field industry, with a much lower need to add a corrosion inhibitor.

### Example 3

The corrosion rate of the L-80 coupons after treatment for 6 hours at 300° F. (approx. 150° C.) in the test fluid and a pressure of 500 psi (approx. 35 bar) in a nitrogen atmosphere with different amounts of corrosion inhibitor is given in Table 5. It can be seen that the corrosion rate of L-80 in a 20 wt % GLDA solution (pH=3.8) without a corrosion inhibitor and with a minor amount of between 0.001 and 0.005 vol % corrosion inhibitor (CI-1; Armohib 31 ex AkzoNobel Surface Chemistry) is lower compared to the corrosion rate of a 20 wt % HEDTA solution (pH=3.8), at a pressure of 500 psi (approx. 35 bar).

TABLE 5
Comparison of the corrosion rate of L-80 coupons in 20 wt % GLDA
solution compared to 20 wt % HEDTA solution at pressure 500 psi
(approx. 35 bar) N₂ and 300° F. (approx. 150° C.)

| | | 6 hour metal loss (LBS/sq. ft) |
|---|---|---|
| Test fluid | Cl-1 (v %) | (g/cm²) |
| 20 wt % GLDA | — | 0.6696 (0.327) |
| 20 wt % GLDA | 0.001 | 0.6571 (0.321) |
| 20 wt % GLDA | 0.005 | 0.0563 (0.027) |
| 20 wt % HEDTA | — | 0.9798 (0.478) |
| 20 wt % HEDTA | 0.001 | 0.9027 (0.441) |
| 20 wt % HEDTA | 0.005 | 0.6073 (0.297) |

The corrosion rate of the L-80 coupons after treatment for 6 hours at 300° F. (approx. 150° C.) in the test fluid and a pressure of >1,000 psi (approx. 70 bar) in a nitrogen atmosphere with different amounts of corrosion inhibitor is given in Table 6. It can be seen that the corrosion rate of L-80 in a 20 wt % GLDA solution (pH=3.8) without a corrosion inhibitor and with a minor amount of 0.001 and 0.005 vol % corrosion inhibitor is lower compared to the corrosion rate of a 20 wt % HEDTA solution (pH=3.8), at a pressure of >1,000 psi (approx. 70 bar).

TABLE 6
Comparison of the corrosion rate of L-80 coupons in 20 wt % GLDA
solution compared to 20 wt % HEDTA solution at pressure >1,000
psi (approx. 70 bar) N₂ and 300° F. (approx. 150° C.).

| | | 6 hour metal loss (LBS/sq. ft) |
|---|---|---|
| Test fluid | Cl-1 (v %) | (g/cm²) |
| 20 wt % GLDA | — | 0.5937 (0.290) |
| 20 wt % GLDA | 0.001 | 0.5647 (0.276) |
| 20 wt % GLDA | 0.005 | 0.0262 (0.013) |
| 20 wt % HEDTA | — | 0.8341 (0.407) |
| 20 wt % HEDTA | 0.001 | 0.6279 (0.307) |
| 20 wt % HEDTA | 0.005 | 0.1300 (0.063) |

Example 3 shows the beneficial behaviour of GLDA solutions under subterranean conditions when compared to HEDTA solutions. It can be seen for both pressures (500 psi (approx. 35 bar) and 1,000 psi (approx. 70 bar)) at elevated temperatures that a very low amount of corrosion inhibitor added to the solution (0.005 vol %) shows a remarkable further reduction of the corrosion rate. Applicant, without wanting to be bound by any theory, attributes this to a surprising synergistic effect of GLDA with the corrosion inhibitor.

### Example 4

The corrosion rate of a 20 wt % GLDA solution (pH=3.8) at 250° F. (approx. 120° C.) and a pressure of >1,000 psi (approx. 70 bar) in a nitrogen atmosphere was shown with various concentrations of different corrosion inhibitors, Armohib 31 (CI-1) and Armohib 5150 (CI-2), both ex Akzo Nobel Surface Chemistry, as summarized in below Table 7.

TABLE 7
Comparison of two corrosion inhibitors in 20 wt % GLDA solution (pH =
3.8), pressure >1,000 psi (approx. 70 bar) N₂ and 250° F. (approx. 121° C.).

| CI-1 | CI-2 | 6 hour metal loss |
|---|---|---|
| (v %) | (v %) | (LBS/sq. ft) (g/cm²) |
| — | — | 0.1186 (0.058) |
| 0.00025 | — | 0.0779 (0.038) |
| 0.0005 | — | 0.0678 (0.033) |
| 0.001 | — | 0.0074 (0.004) |
| — | 0.005 | 0.0908 (0.044) |
| — | 0.01 | 0.0826 (0.040) |
| — | 0.1 | 0.0386 (0.019) |

Example 4 shows that the surprising synergistic effect can be seen for different corrosion inhibitors, at downhole temperature conditions.

### Example 5

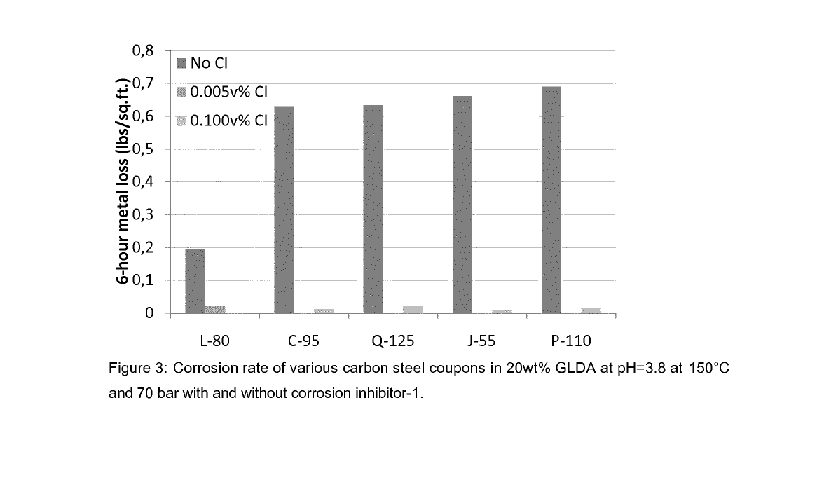

The corrosion behaviour of 20 wt % GLDA solution (pH=3.8) at 300° F. (approx. 150° C.) and a pressure of 1,000 psi (approx. 70 bar) in a nitrogen atmosphere, with and without CI-1, was compared over the following carbon steel metallurgies: L-80, C-95, Q-125, J-55, and P110, which are common carbon steel types used in the oil/gas field that all contain at least one of the metals manganese (Mn) or chromium (Cr) in an amount of at least 0.75 wt %. FIG. 3 shows that an amount of 0.005 v % of CI-1 for L-80 and an amount of 0.100 v % CI-1 for C-95, Q-125, J-55, and P-110 reduces the corrosion rate of the carbon steel metallurgies to well below the acceptable corrosion rate of 0.05 lbs/ft² (approx. 0.0244 g/cm²).

It can be concluded that the use of GLDA in this field is possible for various types of carbon steel that are known to be of great use in the oil field industry with great advantages in the corrosion effects found.

1. A method of treating subterranean formations using a solution containing glutamic acid N,N-diacetic acid or a salt thereof (GLDA) and/or methylglycine N,N-diacetic acid or a salt thereof (MGDA), comprising contacting carbon steel-containing equipment with the solution at a temperature of at least 100° C.

2. The method of claim 1, wherein the carbon steel-containing equipment is cleaned or descaled.

3. The method of claim 1, wherein the solution is an acidic solution.

4. The method of claim 1, wherein the subterranean formation is used in oil and/or gas production, in pickling, completions, stimulation by acidizing, or fracturing.

5. The method of claim 1, wherein the solution in addition contains water and a corrosion inhibitor.

6. The method of claim 5, wherein the amount of corrosion inhibitor is more than 0 up to 3 vol % on total volume of the solution.

7. The method of claim 1, wherein the solution in addition contains one or more of water, solvents, alcohols, glycols, organic solvents, mutual solvents, soaps, surfactants, dispersants, emulsifiers, pH control additives, acids or bases, biocides/bactericides, water softeners, bleaching agents, enzymes, brighteners, fragrances, antifouling agents, antifoaming agents, anti-sludge agents, corrosion inhibitors, corrosion inhibitor intensifiers, viscosifiers, wetting agents, diverting agents, oxygen scavengers, carrier fluids, fluid loss additives, friction reducers, stabilizers, rheology modifiers, gelling agents, scale inhibitors, breakers, salts, brines, particulates, crosslinkers, salt substitutes, relative permeability modifiers, sulfide scavengers, fibres, and nanoparticles.

8. A method of treating subterranean formations using a solution containing glutamic acid N,N-diacetic acid or a salt thereof (GLDA) and/or methylglycine N,N-diacetic acid or a salt thereof (MGDA), comprising contacting carbon steel-containing equipment with the solution, wherein the carbon steel contains at least one of manganese or chromium in an amount of 0.75 wt % or more on the total steel alloy weight.

9. The method of claim 8, wherein the carbon steel is a N-80, L-80, P-110, Q-125, J-55, C-75, C-90, C-95, QT-800, QT-900, 5LX-42 or 5LX-52 carbon steel.

10. The method of claim 8, wherein the carbon steel-containing equipment is cleaned or descaled.

11. The method of claim 8, wherein the solution is an acidic solution.

12. The method of claim 8, wherein the carbon steel-containing equipment is used in oil and/or gas production, in pickling, completions, stimulation by acidizing, or fracturing.

13. The method of claim 8, wherein the solution in addition contains water and a corrosion inhibitor.

14. The method of claim 13, wherein the amount of corrosion inhibitor is more than 0 up to 3 vol % on total volume of the solution.

15. A system containing a carbon steel-containing material in contact with a solution containing glutamic acid N,N-diacetic acid or a salt thereof (GLDA) and/or methylglycine N,N-diacetic acid or a salt thereof (MGDA), wherein the solution has a temperature of at least 100° C. or the carbon steel is a carbon steel wherein at least one of the metals manganese or chromium is present in an amount of 0.75 wt % or more on the total steel alloy weight.

16. The system of claim 15, wherein the carbon steel-containing material is carbon steel-containing equipment, a sheet or plate, a carbon steel-containing part, a screw or nail.

17. The system of claim 15, wherein the carbon steel-containing equipment is a tube, tank, container, vessel, pipe or a device that can hold the solution or through which the solution can flow.

18. The system of claim 15, wherein the carbon steel-containing material contains more than 0 and up to 0.3 wt % of carbon on total weight of the steel alloy.

19. The method of claim 5, wherein the amount of corrosion inhibitor is more than 0 to 1 vol % on total volume of the solution.

20. The method of claim 5, wherein the amount of corrosion inhibitor is more than 0 to 0.5 vol % on total volume of the solution.
